(19) United States
(12) Patent Application Publication
(10) Pub. No.: US 2006/0238963 A1
(43) Pub. Date: Oct. 26, 2006

(54) Monitor supporting combination for vehicle

(76) Inventor: Hsiu-Chu Hsu Li, Hsinju City (TW)

Correspondence Address: CHARLES E. BAXLEY, ESQ., 90 JOHN STREET, THIRD FLOOR, NEW YORK, NY, 10038, US

(21) Appl. No.: 11/027,048

(22) Filed: Dec. 30, 2004

(51) Int. Cl. G06F 1/16

(52) U.S. Cl. 361/681

(57) ABSTRACT

A monitor supporting device for vehicle includes a control panel having a chamber formed by an inner peripheral surface, for receiving a housing and for detachably attaching the housing to the control panel with catches and protrusions. The housing includes a front recess formed by a partition for receiving an electronic device, and includes a rear space located behind the partition, and includes one or more orifices formed in the partition and communicating with the rear space of the housing, for forming an air passage and for air circulating and heat dissipating purpose, and for preventing the electronic device from over-heating, and thus for allowing the working life of the electronic device to be increased.

### BACKGROUND OF THE INVENTION

1. Field of the Invention

The present invention relates to a monitor supporting combination for vehicle, and more particularly to a monitor supporting combination for attaching to a control panel of a vehicle, and having a heat dissipating structure for heat dissipating purposes, and for preventing the monitor from being over-heated or damaged by heat.

2. Description of the Prior Art

Various kinds of typical telecommunication facilities, global systems for mobile communications, internet communications, televisions, etc. have been developed and provided for being used in vehicles, and normally comprise a monitor for showing information of the images or characters of the communications.

For allowing the monitors to be easily used by the users, various kinds of supporting devices or facilities have been developed for attaching or disposing or supporting the monitors within the vehicles.

For example, U.S. Pat. No. 4,843,477 to Mizutani et al. discloses one of the typical vehicle television housing systems including a television receiver for attaching and detaching from the vehicle. It is required to form or provide a housing in the seat back of the vehicle, to receive the television within the housing. However, the television will be enclosed within the housing, and the housing has no air circulating paths formed or provided therein, such that the television may be easily over-heated or damaged. In addition, only the passengers in the rear seats may use or enjoy the monitor or television.

U.S. Pat. No. 5,555,466 to Scribner et al. discloses another typical vehicular audio/visual system having distribution box for connecting individual passenger monitors to multiple program sources. The video monitors are also attached to the seat back of the vehicle, such that only the passengers in the rear seats may use or enjoy the video monitors. In addition, the monitor will also be sealingly enclosed within the seat back, and will have no air circulating paths formed or provided therein, such that the monitor may also be easily damaged with over-heat problems.

U.S. Pat. No. 5,725,189 to Landy discloses a further typical media mounting device for motor vehicles including a wedge-shaped stand portion of light weight material to support an electronic device. However, the stand portion may only be supported between the seats, such that only the passengers in the rear seats may use or enjoy the video monitors.

U.S. Pat. No. 6,092,705 to Meritt discloses a still further typical self contained case for housing transporting and mounting video monitor and video player for use in passenger vehicles. However, similarly, the case may only be supported between the seats, such that only the passengers in the rear seats may use or enjoy the video monitors. In addition, the monitor is also be sealingly enclosed within the case, and will have no air circulating devices formed or provided therein, such that the monitor may also have over-heat problems.

The present invention has arisen to mitigate and/or obviate the afore-described disadvantages of the conventional monitor supporting structures or devices for vehicles.

### SUMMARY OF THE INVENTION

The primary objective of the present invention is to provide a monitor supporting combination for attaching to a control panel of a vehicle, and having a heat dissipating structure for heat dissipating purposes, and for preventing the monitor from being over-heated or damaged by heat.

In accordance with one aspect of the invention, there is provided a monitor supporting combination for vehicle comprising a control panel including a chamber formed therein, and defined by an inner peripheral surface, and including at least one catch extended in the chamber thereof, a housing including a rear portion for engaging into the chamber of the control panel, and including at least one protrusion extended therefrom, for engaging with the catch of the control panel, to detachably attach the housing to the control panel, the housing including a front recess formed therein and defined by a partition, and including a rear space located behind the partition, and including at least one orifice formed in the partition and communicating with the rear space of the housing, for forming an air passage and for air circulating and heat dissipating purpose, and an electronic device receivable in the front recess of the housing, for allowing the electronic device to be attached to the control panel with the housing.

The control panel includes at least one tube extended in the chamber thereof, and the housing includes at least one projection extended therefrom, for engaging with the tube of the control panel, to detachably attach the housing to the control panel.

The housing includes a plate provided therein, to form a pathway therein, and for receiving electric cables therein. The housing includes an upper notch formed therein and communicating with the pathway and the front recess of the housing, for receiving fingers of users.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan view of a control panel of a monitor supporting combination for a vehicle in accordance with the present invention;

FIG. 2 is a partial exploded view of the monitor supporting combination for vehicle;

FIG. 3 is a partial plan view of the monitor supporting combination for vehicle;

FIG. 4 is a front perspective view of a housing of the monitor supporting combination for vehicle; and

FIG. 5 is a rear perspective view of the housing of the monitor supporting combination for vehicle.

### DETAILED DESCRIPTION OF THE PREFERRED EMBODIMENT

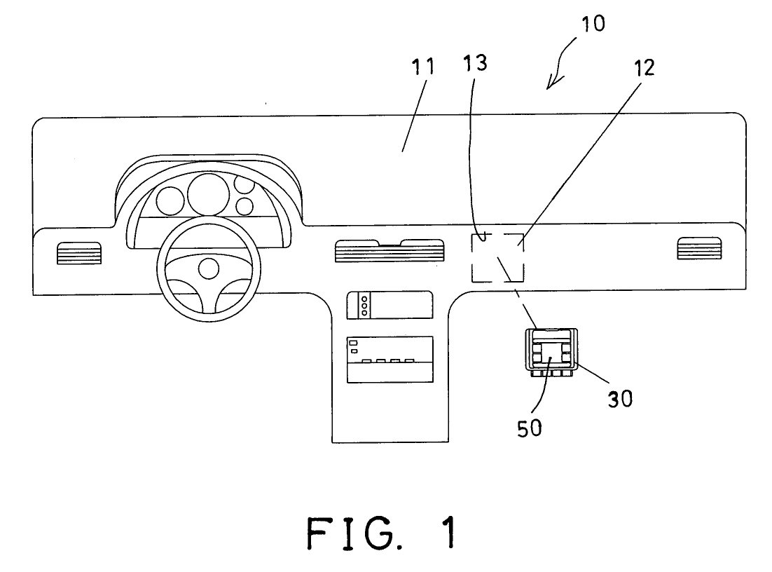

Referring to the drawings, and initially to FIGS. 1-3, a monitor supporting combination 10 for vehicle in accordance with the present invention comprises a control panel 11 that is normally formed or provided within the vehicle, including a chamber 12 formed therein, and defined by an inner peripheral surface 13, and including one or more catches 14 and one or more tubes 15 extended in the chamber 12 thereof.

A housing 30 includes a rear portion 31 to be engaged into the chamber 12 of the control panel 11, and includes one or more protrusions 32 and one or more projections 33 extended therefrom, for engaging with the catches 14 and the tubes 15 of the control panel 11 respectively, to detachably attach or secure or anchor the housing 30 to the control panel 11. The housing 30 includes a recess 34 formed or provided in the front portion thereof, and defined by a partition 35, and having an upper opening 36 formed therein and communicating with the recess 34 thereof, for receiving a monitor 50 or other electronic devices 50 therein.

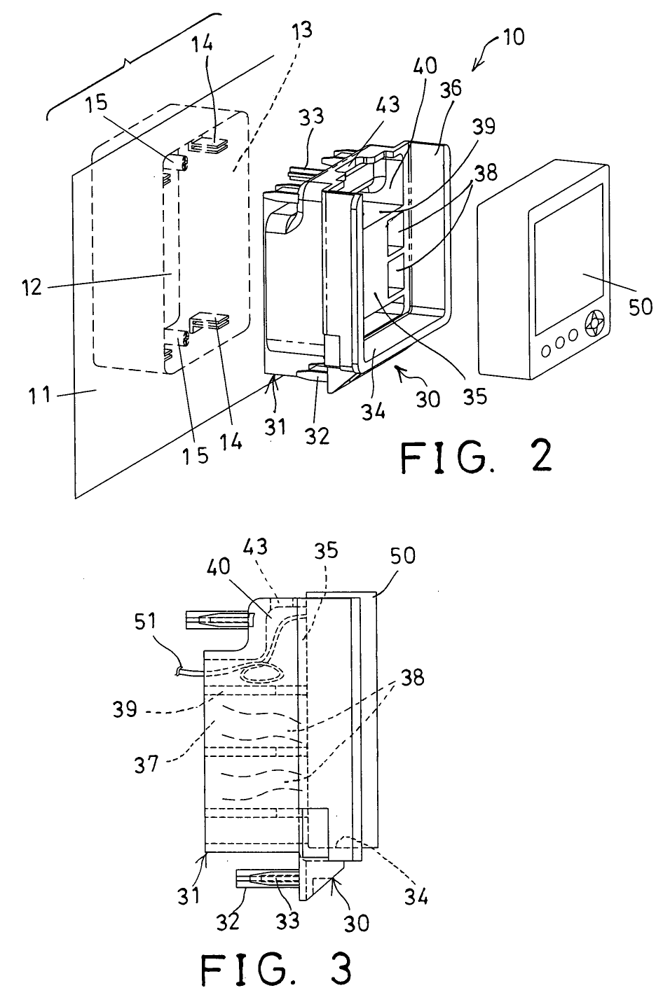

The housing 30 further includes a rear space 37 formed or provided in the rear portion thereof (FIGS. 3, 5), and located behind the partition 35, and includes one or more orifices 38 formed in the partition 35, and communicating with the rear space 37 of the housing 30, for forming air passages, and for air circulating and/or heat dissipating purposes, best shown in FIG. 3. The housing 30 further includes a plate 39 formed or provided therein, such as located in the upper portion thereof (FIGS. 2, 3), for forming a pathway 40 therein, and for receiving electric wires or cables 51 therein (FIG. 3), for example.

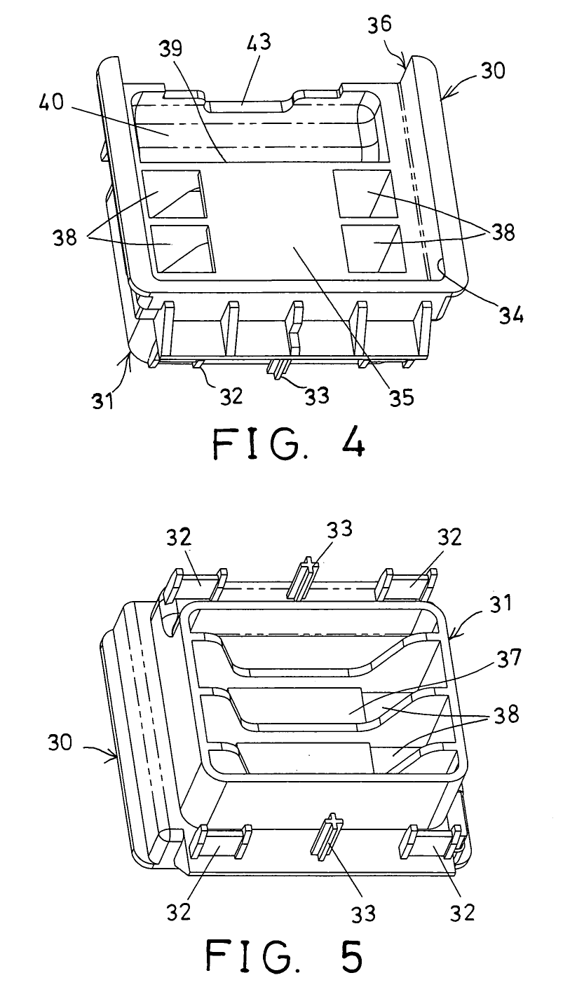

It is preferable that the housing 30 includes a notch 43 formed or provided in the upper portion thereof (FIGS. 2-4), and communicating with the pathway 40 and/or the recess 34 of the housing 30, for allowing fingers of users to engage into the notch 43 of the housing 30, and for allowing the users to easily remove the monitor 50 or electronic device 50 from the housing 30.

It is to be noted that the monitor 50 or electronic device 50 may be attached to the control panel 11 of the vehicle, and may thus be viewed or used by both the drivers and the passengers. In addition, the formation and the provision of the air passages formed or defined by the orifices 38 of the partition 35 and the rear space 37 of the housing 30 may facilitate air circulation through the housing 30, and may facilitate heat dissipating effect of the monitor or electronic device 50, such that the working life of the monitor 50 or electronic device 50 may be increased.

Accordingly, the monitor supporting combination for vehicle in accordance with the present invention may be provided for attaching to a control panel of a vehicle, and having a heat dissipating structure for heat dissipating purposes, and for preventing the monitor from being over-heated or damaged by heat.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A monitor supporting combination for vehicle comprising:
a control panel including a chamber formed therein, and defined by an inner peripheral surface, and including at least one catch extended in said chamber thereof,
a housing including a rear portion for engaging into said chamber of said control panel, and including at least one protrusion extended therefrom, for engaging with said at least one catch of said control panel, to detachably attach said housing to said control panel, said housing including a front recess formed therein and defined by a partition, and including a rear space located behind said partition, and including at least one orifice formed in said partition and communicating with said rear space of said housing, for forming an air passage and for air circulating and heat dissipating purpose, and
an electronic device receivable in said front recess of said housing, for allowing said electronic device to be attached to said control panel with said housing.

2. The monitor supporting combination as claimed in claim 1, wherein said control panel includes at least one tube extended in said chamber thereof, and said housing includes at least one projection extended therefrom, for engaging with said at least one tube of said control panel, to detachably attach said housing to said control panel.

3. The monitor supporting combination as claimed in claim 1, wherein said housing includes a plate provided therein, to form a pathway therein, and for receiving electric cables therein.

4. The monitor supporting combination as claimed in claim 3, wherein said housing includes an upper notch formed therein and communicating with said pathway and said front recess of said housing, for receiving fingers of users.
